(19) United States
(12) Patent Application Publication
(10) Pub. No.: US 2026/0369754 A1
(43) Pub. Date: Nov. 19, 2026

(54) SECONDARY BATTERY AND METHOD FOR MANUFACTURING SECONDARY BATTERY

(71) Applicant: SAMSUNG SDI CO., LTD., Yongin-si (KR)

(72) Inventors: Hyunwoo KIM, Yongin-Si (KR); Hyeongmin JI, Yongin-Si (KR)

(21) Appl. No.: 19/558,737

(22) Filed: Mar. 6, 2026

(30) Foreign Application Priority Data
May 15, 2025 (KR) 10-2025-0063280

(51) Int. Cl. H01M 50/124; H01M 10/0585; H01M 50/119; H01M 50/121; H01M 50/133; H01M 50/105; H01M 50/636

(52) U.S. Cl. CPC H01M 50/1243; H01M 10/0585; H01M 50/119; H01M 50/121; H01M 50/133; H01M 50/105; H01M 50/636

(57) ABSTRACT

A secondary battery includes: an electrode assembly including a first electrode, a second electrode, and a separator between the first electrode and the second electrode; a case accommodating the electrode assembly; and a cured coating layer between the electrode assembly and the case. The cured coating layer includes a curable polymer to be cured by reacting with an electrolyte in an interior of the case.

### CROSS-REFERENCE TO RELATED APPLICATION

The present application claims priority to and the benefit of Korean Patent Application No. 10-2025-0063280, filed on May. 15, 2025, in the Korean Intellectual Property Office, the entire disclosure of which is incorporated by reference herein.

### BACKGROUND

### 1. FIELD

Aspects of embodiments of the present disclosure relate to a secondary battery, and a method for manufacturing the secondary battery.

### 2. DESCRIPTION OF THE RELATED ART

Unlike primary batteries that are not designed to be (re)charged, secondary (e.g., rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

A secondary battery is a chargeable battery, and refers to a battery that may be charged and discharged multiple times. A secondary battery may mainly be used in various suitable application fields, such as electronic devices (e.g., smartphones, laptops, tablets, and the like), electric vehicles (EVs), solar power generation, and emergency power supply (EPS) devices. For example, a lithium-ion battery may be a kind of secondary battery that has a high energy density and a high charge/discharge efficiency, and thus, may be used as an energy storage system (ESS).

The above information disclosed in this Background section is for enhancement of understanding of the background of the present disclosure, and therefore, it may contain information that does not constitute related (or prior) art.

### SUMMARY

In some kinds of secondary batteries, when a thickness of an exterior material is formed to be thinner to improve an energy density, it may be vulnerable to external impacts.

Embodiments of the present disclosure may be directed to a secondary battery, and a method for manufacturing the secondary battery.

However, the present disclosure is not limited thereto, and the above and additional aspects and features will be set forth, in part, in the description that follows, and in part, may be apparent from the description.

According to one or more embodiments of the present disclosure, a secondary battery includes: an electrode assembly including a first electrode, a second electrode, and a separator between the first electrode and the second electrode; a case accommodating the electrode assembly; and a cured coating layer between the electrode assembly and the case. The cured coating layer includes a curable polymer configured to be cured by reacting with an electrolyte in an interior of the case.

In an embodiment, the curable polymer may include an oxazoline polymer.

In an embodiment, the cured coating layer may be cured by the curable polymer reacting with lithium ions in the electrolyte in the interior of the case.

In an embodiment, the cured coating layer may have a thickness of greater than or equal to 1 µm and less than or equal to 10 µm.

In an embodiment, the cured coating layer may be coated on an outer peripheral surface of the electrode assembly.

In an embodiment, the cured coating layer may be coated on an inner peripheral surface of the case.

In an embodiment, the cured coating layer may be coated by spray coating or electro-spray coating.

In an embodiment, the case may include an aluminum laminate film.

According to one or more embodiments of the present disclosure, a method of manufacturing a secondary battery includes: forming an electrode assembly by interposing a separator between a first electrode and a second electrode; preparing a case to accommodate the electrode assembly; forming a cured coating layer including a curable polymer on at least one of the electrode assembly or the case; inserting the electrode assembly into an interior of the case; injecting an electrolyte into the interior of the case; and curing the curable polymer of the cured coating layer by reacting the curable polymer with the electrolyte.

In an embodiment, the curable polymer may include an oxazoline polymer.

In an embodiment, the curing may include reacting the curable polymer with lithium ions in the electrolyte injected into the interior of the case.

In an embodiment, the forming of the cured coating layer may include forming the cured coating layer to have a thickness of greater than or equal to 1 µm and less than or equal to 10 µm.

In an embodiment, the forming of the cured coating layer may include coating the cured coating layer on an outer peripheral surface of the electrode assembly.

In an embodiment, the forming of the cured coating layer may include coating the cured coating layer on an inner peripheral surface of the case.

In an embodiment, the forming of the cured coating layer may include coating the cured coating layer by spray coating or electro-spray coating.

In an embodiment, the method may further include, after the injecting of the electrolyte, sealing an injection port of the case.

In an embodiment, the method may further include, after the sealing of the injection port, inserting the case into a mold, and pressing the mold to fix a shape of the case.

In an embodiment, the electrode assembly may be formed by a stacking method.

In an embodiment, the injecting of the electrolyte may be performed by an electrolyte injection device while an interior of the electrolyte injection device may be in a vacuum state.

In an embodiment, the case may include an aluminum laminate film.

According to some embodiments of the present disclosure, by disposing a cured coating layer that is cured by reacting with an electrolyte between a case and an electrode assembly, a secondary battery having secured rigidity that may not be easily deformed by an external force may be provided. As a result, it may be possible to prevent or substantially prevent damage to the case, and prevent or substantially prevent a short circuit of the electrode assembly, thereby improving the stability and the durability of the secondary battery.

According to some embodiments of the present disclosure, the cured coating layer may form a support skeleton by itself to stably compress/support an interior of the secondary battery, without adding a separate reinforcing structure to an exterior of the case. In addition, a swelling phenomenon that may be caused by heat generated during use of the secondary battery or by heat supplied from the outside may be suppressed.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is an exploded perspective view illustrating an example in which a part of a secondary battery is disassembled according to an embodiment of the present disclosure.

FIG. 2 is a perspective view illustrating a cured coating layer that is coated on an electrode assembly of a secondary battery according to an embodiment of the present disclosure.

FIG. 3 is a perspective view illustrating a cured coating layer that is coated on an interior of a case of a secondary battery according to an embodiment of the present disclosure.

FIG. 4 is a plan view illustrating a secondary battery according to an embodiment of the present disclosure.

FIG. 5 is a cross-sectional view illustrating the secondary battery taken along the line X-X' of FIG. 4.

FIG. 6 is a cross-sectional view illustrating a state in which an electrolyte is injected into the secondary battery of FIG. 5.

FIG. 7 is an enlarged view of the region A of FIG. 6.

FIG. 8 is a flowchart illustrating an example of a method for manufacturing a secondary battery according to an embodiment of the present disclosure.

FIG. 9 is a perspective view illustrating an electrode assembly formed by a stacking method.

FIG. 10 is a schematic diagram illustrating a coating process of a cured coating layer on the electrode assembly of FIG. 9.

FIG. 11 is a schematic diagram illustrating a fixing process of a shape of a case by inserting the case into a mold.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein.

References to two compared elements, features, and the like as being “the same” as each other may mean that they are “substantially the same” as each other. Thus, the phrase “substantially the same” may include a case having a deviation or a variation that is considered low in the art, for example, such as a deviation or variation of 5% or less. In addition, when a certain parameter is referred to as being uniform in a given region, it may mean that it is uniform in terms of an average.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

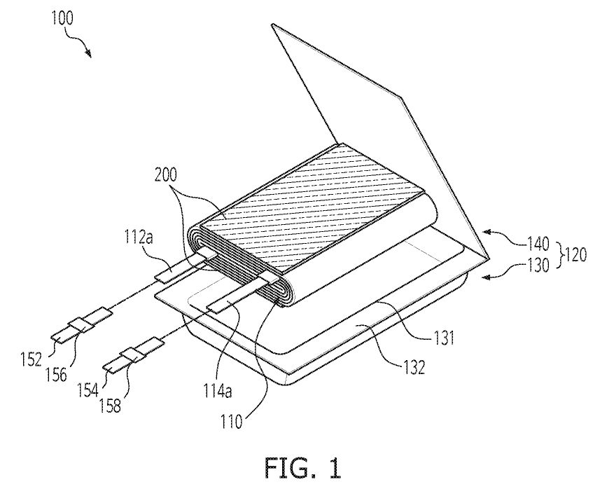

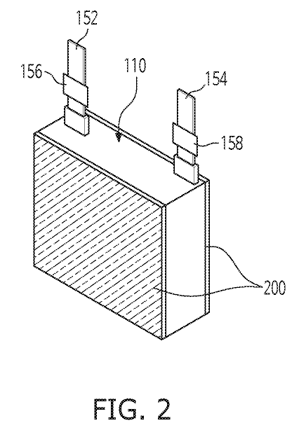

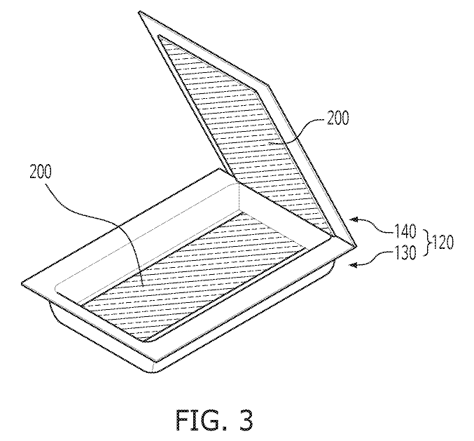

FIG. 1 is an exploded perspective view illustrating an example in which a part of a secondary battery is disassembled according to an embodiment of the present disclosure. FIG. 2 is a perspective view illustrating a cured coating layer that is coated on an electrode assembly of a secondary battery according to an embodiment of the present disclosure. FIG. 3 is a perspective view illustrating a cured coating layer that is coated on an interior of a case of a secondary battery according to an embodiment of the present disclosure.

A secondary battery 100 according to an embodiment of the present disclosure may include an electrode assembly 110, a case 120 accommodating the electrode assembly 110 therein, and a cured coating layer 200 disposed between the electrode assembly 110 and the case 120.

The secondary battery 100 may be a lithium battery cell (e.g., a lithium-ion battery cell), a sodium battery cell, or the like. However, the present disclosure is not limited thereto, and the secondary battery 100 may include any suitable kind of battery that may repeatedly provide electricity by charging and discharging. In an embodiment, when the secondary battery 100 is a lithium battery cell, the secondary battery 100 may be used in an electric vehicle (EV) because of its excellent life characteristics and high-rate characteristics. In some embodiments, the secondary battery 100 may be used in a hybrid vehicle, such as a plug-in hybrid electric vehicle (PHEV). A lithium battery cell may be used in a field requiring or desiring a large amount of power storage, for example, such as in an electric bicycle, a power tool, or the like, but the present disclosure is not limited thereto.

The electrode assembly 110 may include a first electrode, a second electrode, and a separator interposed between the first electrode and the second electrode. For example, the electrode assembly 110 may have a stacking structure in which the first electrode and the second electrode, which are made of a plurality of sheets, are alternately stacked with the separator therebetween. However, the present disclosure is not limited thereto, and the electrode assembly 110 may be formed by being wound with the separator interposed between the first electrode and the second electrode.

A positive electrode for a rechargeable lithium battery may include a current collector, and a positive electrode active material layer on the current collector. The positive electrode active material layer may include a positive electrode active material, and may further include a binder and/or a conductive material (e.g., an electrically conductive material).

For example, the positive electrode may further include an additive that may serve as a sacrificial positive electrode.

An amount of the positive electrode active material may be about 90 wt% to about 99.5 wt% based on 100 wt% of the positive electrode active material layer. Amounts of the binder and the conductive material may be about 0.5 wt% to about 5 wt%, respectively, based on 100 wt% of the positive electrode active material layer.

The binder serves to attach the positive electrode active material particles to each other, and also to attach the positive electrode active material to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as some non-limiting examples.

The conductive material may be used to impart a conductivity (e.g., an electrical conductivity) to the electrode. Any suitable material that does not cause a chemical change (e.g., that does not cause an undesirable chemical change in the rechargeable lithium battery) and conducts electrons may be used in the battery. Examples of the conductive material may include a carbon-based material, such as natural graphite, artificial graphite, carbon black, acetylene black, ketjen black, a carbon fiber, a carbon nanofiber, and/or carbon nanotube, a metal-based material containing copper, nickel, aluminum, silver, and/or the like in a form of a metal powder or a metal fiber, a conductive polymer, such as a polyphenylene derivative, or a suitable mixture thereof.

Aluminum (Al) may be used as the current collector, but the present disclosure is not limited thereto.

The separator may include polyethylene, polypropylene, polyvinylidene fluoride, or a multilayered film of two or more layers thereof, and a mixed multilayered film, such as a polyethylene/polypropylene two-layered separator, a polyethylene/polypropylene/polyethylene three-layered separator, a polypropylene/polyethylene/polypropylene three-layered separator, and/or the like.

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include about 90 wt% to about 99 wt% of the negative electrode active material, about 0.5 wt% to about 5 wt% of the binder, and about 0 wt% to about 5 wt% of the conductive material.

The binder may serve to attach the negative electrode active material particles to each other, and also to attach the negative electrode active material to the current collector. The binder may include a non-aqueous binder, an aqueous binder, a dry binder, or a suitable combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a suitable combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and/or a suitable combination thereof.

When an aqueous binder is used as the negative electrode binder, a cellulose-based compound capable of imparting a viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a suitable combination thereof.

The conductive material may be used to impart a conductivity (e.g., an electrical conductivity) to the electrode. Any suitable material that does not cause a chemical change (e.g., that does not cause an undesirable chemical change in the rechargeable lithium battery) and that conducts electrons may be used in the battery. Non-limiting examples thereof may include a carbon-based material, such as natural graphite, artificial graphite, carbon black, acetylene black, ketjen black, a carbon fiber, a carbon nanofiber, and/or a carbon nanotube, a metal-based material including copper, nickel, aluminum, silver, and/or the like in a form of a metal powder or a metal fiber, a conductive polymer, such as a polyphenylene derivative, or a suitable mixture thereof.

The negative current collector may include a copper foil, a nickel foil, a stainless steel foil, a titanium foil, a nickel foam, a copper foam, a polymer substrate coated with a conductive metal, or a suitable combination thereof.

The separator may include a porous substrate, and a coating layer including an organic material, an inorganic material, or a suitable combination thereof on one or both surfaces of the porous substrate.

The porous substrate may be a polymer film formed of any one selected from polymer polyolefin, such as polyethylene and polypropylene, polyester, such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and/or polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and/or a suitable combination thereof, but the present disclosure is not limited thereto.

The organic material and the inorganic material may be mixed in one coating layer, or a coating layer including an organic material and a coating layer including an inorganic material may be stacked.

The first electrode may be formed as a negative electrode plate, and the second electrode may be formed as a positive electrode plate. As another example, the first electrode and the second electrode may be formed reversely. For example, when the first electrode is formed as a negative electrode plate, the first electrode may be formed by applying a negative electrode active material layer mainly composed of a carbon material to at least one surface of a negative electrode current collector of a thin copper foil. In some embodiments, a negative electrode uncoated portion, which is an area where the negative electrode active material layer is not coated, may be formed at both ends (e.g., opposite ends) of the negative electrode current collector.

The negative electrode active material may include a suitable material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon, or a suitable combination thereof. The crystalline carbon may be graphite, such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium, and a metal selected from Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material or a Sn-based negative electrode active material. The Si-based negative electrode active material may include silicon, a silicon-carbon composite, SiOx (0 < x < 2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

When the second electrode is formed as a positive electrode plate, the second electrode may be formed by applying a positive electrode active material layer mainly composed of a lithium-based oxide to at least one surface of a positive electrode current collector formed of a thin aluminum foil. In some embodiments, a positive electrode uncoated portion, which is an area where the positive electrode active material layer is not coated, may be formed at both ends of the positive electrode current collector.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

As an embodiment, in the electrode assembly 110, a first electrode tab 112a may be formed on one side of the first electrode, and a second electrode tab 114a may be formed on one side of the second electrode. The first electrode tab 112a and the second electrode tab 114a may be formed by welding tabs to uncoated portions of the first electrode and the second electrode, and may be formed by stamping the uncoated portions of the first electrode and the second electrode. For example, when the electrode assembly 110 is in a wound state, the first electrode tab 112a and the second electrode tab 114a may be disposed in parallel or substantially in parallel with each other at an interval (e.g., a predetermined interval). When the first electrode is formed as a negative electrode plate, the first electrode tab 112a is formed as a negative electrode tab, and the second electrode tab 114a may be formed as a positive electrode tab. In some embodiments, when a polarity of the first electrode and the second electrode is reversed, the first electrode tab 112a may be formed as a positive electrode tab, and the second electrode tab 114a may be formed as a negative electrode tab.

The first electrode tab 112a and the second electrode tab 114a may be coupled to a first electrode terminal 152 and a second electrode terminal 154, respectively, so that the electrode assembly 110 is electrically connected to the outside. Hereinafter, when referring to both the first electrode tab 112a and the second electrode tab 114a, the first electrode tab 112a and the second electrode tab 114a may be referred to as electrode tabs 112a, 114a, and when referring to both the first electrode terminal 152 and the second electrode terminal 154, the first electrode terminal 152 and the second electrode terminal 154 may be referred to as electrode terminals 152, 154.

A part of the electrode terminals 152, 154 may be formed to be exposed to the outside of the case 120. The electrode tabs 112a, 114a and the electrode terminals 152, 154 may be generally formed of a metal, such as aluminum, copper, or nickel. For example, the electrode tabs 112a, 114a and the electrode terminals 152, 154 may be formed of a metal having an electrical conductivity greater than or equal to a suitable level (e.g., a certain or predetermined level) in order to minimize or reduce a voltage drop.

The electrode terminals 152, 154 may be formed to include terminal covering films 156, 158 located on any one or both of upper surfaces and lower surfaces thereof, respectively. For example, the electrode terminals 152, 154 may be formed to include the terminal covering films 156, 158 attached to a portion in contact with a sealing portion of an edge of the case 120.

In an embodiment, the case 120 may accommodate the electrode assembly 110. The case 120 may include an aluminum laminate film. In this case, a weight of the secondary battery 100 may be reduced, and a durability may be improved. The case 120 may protect the secondary battery including the electrode assembly 110 and an electrolyte introduced into an interior thereof by a subsequent process. For example, the case 120 forms the overall appearance of the secondary battery 100, and may be formed of a conductive metal, such as aluminum, an aluminum alloy, or a nickel-plated steel.

In some embodiments, the case 120 may provide a space in which the electrode assembly 110 is accommodated. According to an embodiment, the case 120 may be a pouch-kind of case, and the secondary battery 100 may be a pouch-kind of secondary battery. For example, the case 120 may be a flexible case in which a pouch case is formed of multiple layers. However, the present disclosure is not limited thereto, and the secondary battery 100 may be a battery cell of any suitable shape, such as a prismatic kind, a cylindrical kind, or the like.

In an embodiment, the case 120 may be formed to include an upper case 140 and a lower case 130, which are formed by folding a middle of an approximately rectangular case film, which may be formed integrally, based on a length direction of one side. In a substantially central region of the lower case 130, an accommodation portion 131 in which the electrode assembly 110 is accommodated may be formed by press processing or the like. In an embodiment, an extension portion 132 may be formed in four directions on an upper edge of the accommodation portion 131.

The upper case 140 may be coupled to an open one end of the lower case 130 to seal the lower case 130. According to an embodiment, one surface of the lower case 130 may be opened, and the upper case 140 may seal the opened one surface of the lower case 130.

In an embodiment, the case 120 may include an electrolyte injection port. For example, the electrolyte injection port may be a through-hole formed in the case 120. After the upper case 140 is coupled to an opening of the lower case 130 and sealed, the electrolyte injection port may be formed to inject an electrolyte into an interior of the case 120. The electrolyte injection port may be sealed with a sealing member after the electrolyte is injected.

In an embodiment, when a flexible pouch is used as an exterior material of the secondary battery 100, a thickness may be significantly reduced compared to that of a can, so that more electrode assemblies may be accommodated in the same volume. In other words, a capacity of the secondary battery may be significantly increased. In some embodiments, because the exterior material may be flexible, the secondary battery may be more easily manufactured in a desired shape, and thus, may be easy to mount on various external sets.

However, despite an increase in a battery capacity and a processability into various suitable shapes, the pouch-kind of secondary battery may have a weak strength, which may cause various side problems. For example, when a pouch-kind of exterior material is pierced by a sharp object, a hole may be easily formed, and the strength may be weaker than that of a prismatic can kind. Furthermore, when a sharp object penetrates the exterior material and comes into contact with an internal electrode assembly, the positive electrode plate and the negative electrode plate may be directly short-circuited, and the secondary battery may ignite or explode.

In some embodiments, when a temperature of the battery becomes greater than or equal to a reference temperature according to a heat generation phenomenon of the secondary battery, the electrode assembly or the electrolyte may be decomposed, and as a result, a large amount of gas may be generated. In this case, the exterior material may swell too easily because the exterior material is flexible/ductile. In some embodiments, in addition to heat generated by itself, a swelling phenomenon of the exterior material may severely occur due to heat supplied from the outside.

According to an embodiment of the present disclosure, the cured coating layer 200 may disposed between the electrode assembly 110 and the case 120. The cured coating layer 200 may perform a protective layer function of the secondary battery 100 together with the case 120. For example, the cured coating layer 200 may be disposed between the case 120 and the electrode assembly 110 to form an internal skeleton of the secondary battery. As such, a strength and a stability of the secondary battery may be secured, and a swelling phenomenon that may be caused by heat generated by itself or heat supplied from the outside may be prevented or substantially prevented.

In an embodiment, the cured coating layer 200 may include a curable polymer that is cured by reacting with an electrolyte injected into an interior of the case 120. The cured coating layer 200 may be cured by reacting with lithium ions of the electrolyte injected into the interior of the case. For example, the cured coating layer 200 may include an oxazoline polymer. The oxazoline polymer may be rapidly cured by reacting with the electrolyte, and may form a stable protective film between the electrode assembly 110 and the case 120.

An electrolyte of a lithium-ion battery may be composed of a lithium salt, an organic solvent, and an additive. The cured coating layer 200 may be chemically cured by reacting with the electrolyte. For example, lithium ions included in the electrolyte may be combined with the curable polymer of the cured coating layer 200 to convert the cured coating layer 200 into a hard solid state.

The electrolyte solution for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, or a suitable combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone and/or the like. The alcohol-based solvent may include ethanol, isopropyl alcohol, and/or the like, and the aprotic solvent may include nitriles, such as R-CN (wherein R is a C2 to C20 linear, branched, or cyclic hydrocarbon group, a double bond, an aromatic ring, or an ether bond), and/or the like; amides such as dimethylformamide; dioxolanes such as 1,3-dioxolane, 1,4-dioxolane, and/or the like; sulfolanes, and/or the like.

The non-aqueous organic solvents may be used alone or in any suitable combination of two or more.

In addition, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF6, LiBF4, LiSbF6, LiAsF6, LiClO4, LiAlO2, LiAlCl4, LiPO2F2, LiCl, LiI, LiN(SO3C2F5)2, Li(FSO2)2N (lithium bis(fluorosulfonyl)imide, LiFSI), LiC4F9SO3, LiN(CxF2x+1SO2)(CyF2y+1SO2) (wherein x and y are integers of 1 to 20), lithium trifluoromethane sulfonate, lithium tetrafluoroethanesulfonate, lithium difluorobis(oxalato)phosphate (LiDFOB), and/or lithium bis(oxalato) borate (LiBOB).

An oxazoline polymer included in the cured coating layer 200 may be a polymer material having a property of being cured by reacting with an electrolyte. The oxazoline polymer may be rapidly cured by reacting with lithium ions of the electrolyte. For example, the oxazoline polymer is a polymer including an oxazoline group, and may include poly(oxazoline), poly(2-methyl-2-oxazoline), and poly(2-ethyl-2-oxazoline). In some embodiments, the oxazoline polymer may include a poly(oxazoline-oxazolidine) copolymer as an oxazoline/oxazolidine-based copolymer.

In some embodiments, the oxazoline polymer may include a poly(oxazoline-amino acid) copolymer which is a copolymer based on oxazoline and an amino acid, a poly(oxazoline-acrylic) copolymer which is an oxazoline and acrylic polymer copolymer, and poly(oxazoline)-phenylene diisocyanate which is an oxazoline-based crosslinkable polymer. In some embodiments, the oxazoline polymer may include an oxazoline-epoxy polymer which is an oxazoline-based epoxy polymer, and an oxazoline nanocomposite which is an oxazoline-based nanocomposite polymer.

In an embodiment, the cured coating layer 200 may be a mixture in which an oxazoline polymer and additives such as a wetting agent and an antifoaming agent are combined.

The secondary battery 100 may have improved mechanical strength and impact resistance by further forming the cured coating layer 200 having an excellent strength inside the case 120, which may be a flexible exterior material. For example, even when the case 120 is pierced by a sharp object, the case 120 may not be easily penetrated, and a phenomenon in which an electrode assembly inside the case 120 may be short-circuited with each other may be prevented or substantially prevented.

In an embodiment, the cured coating layer 200 may be formed by being coated on an outer peripheral surface of the electrode assembly 110. For example, as illustrated in FIG. 2, the cured coating layer 200 may be coated on both (e.g., opposite) wide surfaces of the electrode assembly 110. In another example, the cured coating layer may be coated on an entire surface of the electrode assembly 110, except for a region where the electrode terminals 152, 154 and the terminal covering films 156, 158 protrude. The cured coating layer 200 may be coated to a suitable thickness (e.g., a predetermined thickness) on a surface of the electrode assembly 110.

In another embodiment, the cured coating layer 200 may be formed by being coated on an inner peripheral surface of the case 120. For example, the cured coating layer 200 may be coated on an inner peripheral surface of the upper case 140 and an inner peripheral surface of the lower case 130. Referring to FIG. 3, the cured coating layer 200 is illustrated as being coated on (e.g., only on) a lower surface of the lower case 130, but the present disclosure is not limited thereto. For example, the cured coating layer 200 may be coated on an entire space of the lower case 130 that accommodates the electrode assembly.

In an embodiment, the cured coating layer 200 may be coated by a spray coating method or an electro-spray coating method. The cured coating layer 200 may be coated in a uniform or substantially uniform distribution by being coated by a spray coating method or an electro-spray coating method, and a thickness of the target cured coating layer 200 may be easily adjusted.

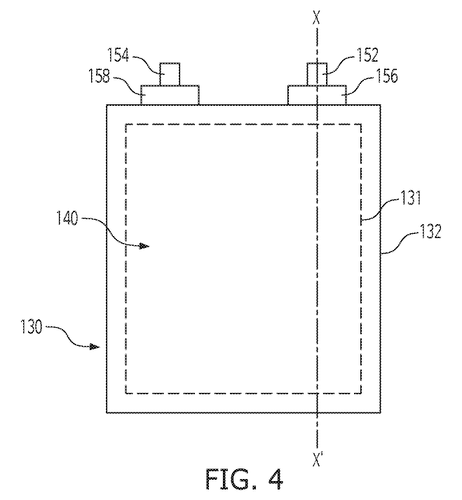

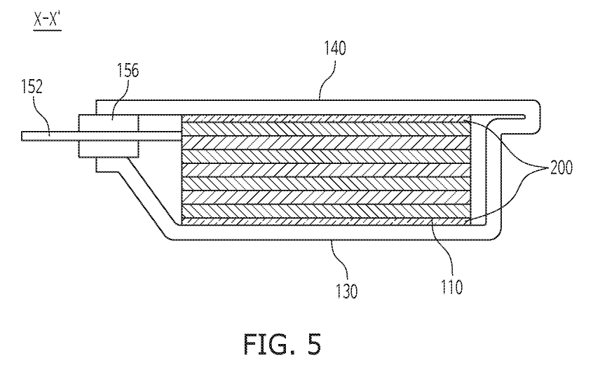

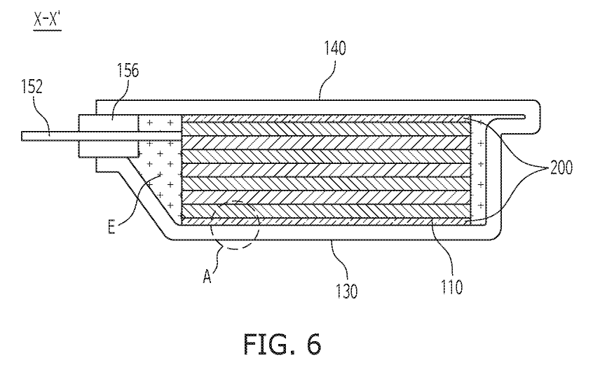

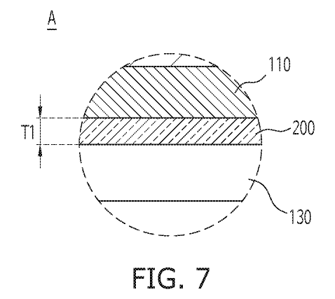

FIG. 4 is a plan view illustrating a secondary battery according to an embodiment of the present disclosure. FIG. 5 is a cross-sectional view illustrating the secondary battery taken along the line X-X' of FIG. 4. FIG. 6 is a cross-sectional view illustrating a state in which an electrolyte is injected into the secondary battery of FIG. 5. FIG. 7 is an enlarged view of the region A of FIG. 6.

According to some embodiments, the secondary battery illustrated in FIGS. 4-6 may be the same or substantially the same as the assembly of the components of the secondary battery described above with reference to FIG. 1. The electrode assembly 110 may be disposed in the accommodation portion 131 of the sealed case 120.

The extension portion 132 of the lower case 130 may be a remaining portion after forming the accommodation portion 131 by a press-processing of the lower case 130, and may be formed in a suitable shape extending in a direction away from the accommodation portion 131. For example, the extension portion 132 may be sealed by being thermocompression-bonded with an edge portion of the upper case 140 after the electrode assembly 110 is accommodated in the accommodation portion 131.

In an embodiment, at least a part of the electrode terminals 152, 154 may protrude to outside the case. For example, as illustrated in FIG. 4, at least a part of the electrode terminals 152, 154 may protrude from upper ends of the lower case 130 and the upper case 140 along an upward direction.

The extension portion 132 may include a sealing surface formed to extend in a direction in which the electrode terminals 152, 154 are drawn out. The sealing surface of the extension portion 132 may correspond to an upper region of the extension portion 132. The sealing surface of the extension portion 132 may come into contact with the terminal covering films 156, 158 that surround (e.g., around peripheries of) the electrode terminals 152, 154 when sealing the upper case 140 and the lower case 130.

In an embodiment, at least a part of the terminal covering films 156, 158 may protrude to the outside of the case. For example, as illustrated in FIG. 4, at least a part of the terminal covering films 156, 158 may protrude from upper ends of the lower case 130 and the upper case 140 along an upward direction. However, the present disclosure is not limited thereto, and for example, the terminal covering films 156, 158 may not be exposed to the outside of the case.

The terminal covering films 156, 158 according to an embodiment of the present disclosure may have a suitable shape and a suitable size corresponding to an area of a portion where the electrode terminals 152, 154 and the lower case 130 and the upper case 140 are in contact with one another. Under a normal state in which the secondary battery operates normally, the terminal covering films 156, 158 may seal between the electrode terminals 152, 154 and the lower case 130 and the upper case 140. The terminal covering films 156, 158 may prevent or substantially prevent foreign substances or the like from flowing into an interior of the secondary battery from the outside.

In an embodiment, a thickness T1 of the cured coating layer 200 may be formed to be greater than or equal to 1 µm and less than or equal to 10 µm. The thickness T1 of the cured coating layer 200 may be set (e.g., may be optimized) to sufficiently initiate a reaction with the electrolyte E while not affecting the performance of the electrode assembly 110. The cured coating layer 200 may be cured by reacting with the electrolyte E injected into the interior of the case. A thickness of the cured coating layer 200 may be the same before and after being cured by reacting with the electrolyte E.

When the thickness T1 of the cured coating layer 200 is less than 1 µm, an uncoated portion may be generated, which may deteriorate a uniformity of the coating. When the thickness T1 of the cured coating layer 200 is greater than 10 µm, the coating layer may flow into a sealing portion of the lower case 130 and the upper case 140.

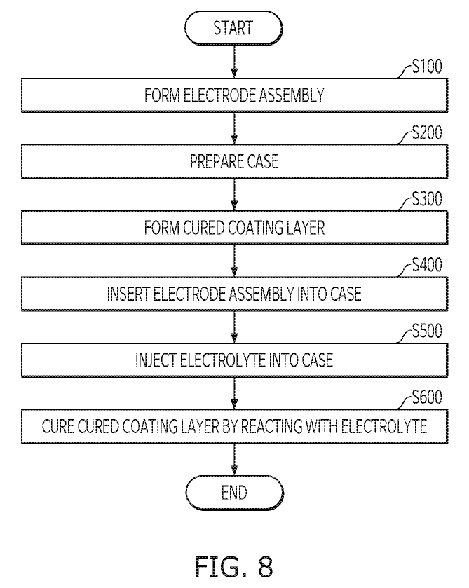

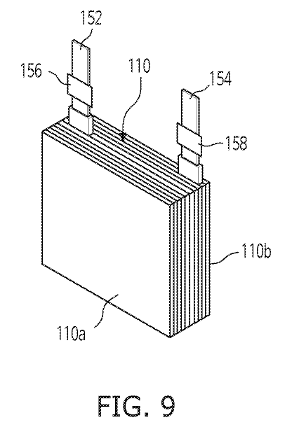

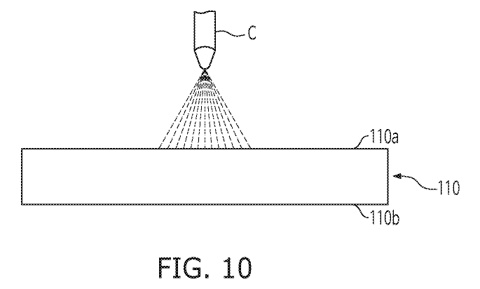

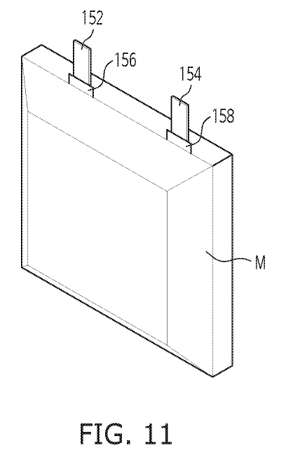

FIG. 8 is a flowchart illustrating an example of a method for manufacturing a secondary battery according to an embodiment of the present disclosure. FIG. 9 is a perspective view illustrating an electrode assembly formed by a stacking method. FIG. 10 is a schematic diagram illustrating a coating process of a cured coating layer on the electrode assembly of FIG. 9. FIG. 11 is a schematic diagram illustrating a fixing process of a shape of a case by inserting the case into a mold.

Referring to FIGS. 8-11, a method for manufacturing a secondary battery may start, and an electrode assembly may be formed S100. A case may be prepared S200, a cured coating layer may be formed S300, the electrode assembly may be inserted into the case S400, an electrolyte may be injected S500, the cured coating layer may be cured by reacting with the electrolyte S600, and the method may end.

The electrode assembly 110 may be formed S100 by interposing a separator between a first electrode and a second electrode. For example, the electrode assembly S100 may be formed by a stacking method. The stacking method may refer to a method of cutting a positive electrode, a negative electrode, and a separator to a suitable length (e.g., a specific or predetermined length), and then stacking the positive electrode, the negative electrode, and the separator layer by layer in a secondary battery electrode assembly manufacturing process. The stacking method may be a Z-folding method or a lamination method.

For example, the electrode assembly 110 may be formed by alternately stacking a plurality of first electrodes, a plurality of separators, and a plurality of second electrodes. First electrode terminals 152 of the plurality of first electrodes may be formed in the same direction as each other, and thus, may be stacked to face each other. Similarly, second electrode terminals 154 of the plurality of second electrodes may be formed in the same direction as each other, and thus, may be stacked to face each other.

In an embodiment, the case may be prepared S200 to accommodate the electrode assembly 110. For example, the case may include an aluminum laminate film. After the preparing of the case S200, the cured coating layer may be formed S300. The forming of the cured coating layer S300 may include forming the cured coating layer including a curable polymer on at least one of the electrode assembly or the case.

In an embodiment, the forming of the cured coating layer S300 may include coating the cured coating layer on an outer peripheral surface of the electrode assembly. For example, as illustrated in FIGS. 9 and 10, the cured coating layer may be coated on both (e.g., opposite) wide surfaces 110a, 110b of the electrode assembly 110. The forming of the cured coating layer S300 may include coating the cured coating layer by a spray coating method or an electro-spray coating method. For example, a coater C may be operated to spray a cured coating layer material on one surface 110a of the electrode assembly 110 by a spray coating method or an electro-spray coating method, and the cured coating layer may be uniformly or substantially uniformly coated on the one surface 110a of the electrode assembly 110.

In another embodiment, the forming of the cured coating layer S300 may include coating the cured coating layer on an inner peripheral surface of the case. For example, the coater C may be operated to spray a cured coating layer material on an inner peripheral surface of the case by a spray coating method or an electro-spray coating method, and the cured coating layer may be uniformly or substantially uniformly coated on the inner peripheral surface of the case. The forming of the cured coating layer S300 may include forming the cured coating layer to have a thickness of greater than or equal to 1 µm and less than or equal to 10 µm.

After the forming of the cured coating layer S300, the electrode assembly may be inserted into the case S400. The inserting of the electrode assembly 110 into the case S400 may include inserting the electrode assembly 110 into an accommodation space formed inside the case. After the inserting of the electrode assembly 110 into the case, an electrolyte may be injected S500.

The electrolyte may be injected S500 into an interior of the case. In an embodiment, the injecting of the electrolyte S500 may be performed while an interior of an electrolyte injection device is in a vacuum state. For example, the injecting of the electrolyte S500 may be performed by placing the case in a state where the electrode assembly is inserted in a vacuum chamber, and injecting the electrolyte through an injection port of the case while an interior of the chamber is in a vacuum state.

As such, a contact between the electrolyte or the cured coating layer and air may be minimized or reduced, and an airtightness of the secondary battery may be increased to prevent or substantially prevent a leakage or a deterioration of the electrolyte. In some embodiments, it may be possible to prevent or substantially prevent foreign substances from flowing into an interior of the case, and a chemical reaction between the electrolyte and the cured coating layer may be more efficiently induced.

In an embodiment, the method may further include sealing an injection port of the case after the injecting of the electrolyte S500. For example, the injection port of the case may be sealed through a thermal fusion or the like after the electrolyte injection.

After the sealing of the injection port, the method may further include inserting the case into a mold M, and pressing the mold M to fix a shape of the case. The mold M may have a suitable shape and a suitable size of the secondary battery to be formed, and the case may be pressure-molded to match the shape of the mold M. The fixing of the shape of the case fixes the shape of the case using the mold M, and increases a surface bonding strength of an inner peripheral surface of the case or an outer peripheral surface of the electrode assembly and the cured coating layer, thereby improving the strength of the entire secondary battery.

After the injecting of the electrolyte S500, the cured coating layer may be cured S600, and the method may end. The curing of the cured coating layer S600 may include curing the curable polymer of the cured coating layer by reacting with the electrolyte. The cured coating layer may include an oxazoline polymer, and the curing S600 may include curing the cured coating layer by reacting with lithium ions of the electrolyte injected into an interior of the case. For example, the curing S600 may be performed while the shape of the case is being fixed by pressing the mold M in a state where the case is inserted into the mold M.

The cured coating layer may be cured between the case and the electrode assembly in the curing S600, and may be converted into a hard solid state. As such, the cured coating layer may function as a protective layer of the secondary battery 100 together with the case, and a strength and a stability of the secondary battery may be secured. In some embodiments, the cured coating layer may function as an internal skeleton of the case, and may prevent or substantially prevent a swelling phenomenon that may be caused by heat generated during use of the secondary battery, or heat supplied from the outside.

The above description of the method with reference to FIG. 8 are provided as an example of some embodiments of the present disclosure, but the present disclosure is not limited thereto. For example, one or more processes of the method described above may be added/changed/deleted, an order of one or more processes may be changed, and/or one or more processes may be performed concurrently (e.g., simultaneously or substantially simultaneously) with each other.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SOME REFERENCE SYMBOLS

100: secondary battery

110: electrode assembly

120: case

130: lower case 1

140: upper case

112a, 114a: electrode tab

152, 154: electrode terminal

156, 158: terminal covering film

200: cured coating layer

What is claimed is:

1. A secondary battery comprising:
an electrode assembly comprising a first electrode, a second electrode, and a separator between the first electrode and the second electrode;
a case accommodating the electrode assembly; and
a cured coating layer between the electrode assembly and the case,
wherein the cured coating layer comprises a curable polymer configured to be cured by reacting with an electrolyte in an interior of the case.

2. The secondary battery as claimed in claim 1, wherein the curable polymer comprises an oxazoline polymer.

3. The secondary battery as claimed in claim 1, wherein the cured coating layer is cured by the curable polymer reacting with lithium ions in the electrolyte in the interior of the case.

4. The secondary battery as claimed in claim 1, wherein the cured coating layer has a thickness of greater than or equal to 1 µm and less than or equal to 10 µm.

5. The secondary battery as claimed in claim 1, wherein the cured coating layer is coated on an outer peripheral surface of the electrode assembly.

6. The secondary battery as claimed in claim 1, wherein the cured coating layer is coated on an inner peripheral surface of the case.

7. The secondary battery as claimed in claim 1, wherein the cured coating layer is coated by spray coating or electro-spray coating.

8. The secondary battery as claimed in claim 1, wherein the case comprises an aluminum laminate film.

9. A method of manufacturing a secondary battery, the method comprising:
forming an electrode assembly by interposing a separator between a first electrode and a second electrode;
preparing a case to accommodate the electrode assembly;
forming a cured coating layer comprising a curable polymer on at least one of the electrode assembly or the case;
inserting the electrode assembly into an interior of the case;
injecting an electrolyte into the interior of the case; and
curing the curable polymer of the cured coating layer by reacting the curable polymer with the electrolyte.

10. The method of manufacturing the secondary battery as claimed in claim 9, wherein the curable polymer comprises an oxazoline polymer.

11. The method of manufacturing the secondary battery as claimed in claim 9, wherein the curing comprises reacting the curable polymer with lithium ions in the electrolyte injected into the interior of the case.

12. The method of manufacturing the secondary battery as claimed in claim 9, wherein the forming of the cured coating layer comprises forming the cured coating layer to have a thickness of greater than or equal to 1 µm and less than or equal to 10 µm.

13. The method of manufacturing the secondary battery as claimed in claim 9, wherein the forming of the cured coating layer comprises coating the cured coating layer on an outer peripheral surface of the electrode assembly.

14. The method of manufacturing the secondary battery as claimed in claim 9, wherein the forming of the cured coating layer comprises coating the cured coating layer on an inner peripheral surface of the case.

15. The method of manufacturing the secondary battery as claimed in claim 9, wherein the forming of the cured coating layer comprises coating the cured coating layer by spray coating or electro-spray coating.

16. The method of manufacturing the secondary battery as claimed in claim 9 further comprising, after the injecting of the electrolyte, sealing an injection port of the case.

17. The method of manufacturing the secondary battery as claimed in claim 16 further comprising, after the sealing of the injection port, inserting the case into a mold, and pressing the mold to fix a shape of the case.

18. The method of manufacturing the secondary battery as claimed in claim 9, wherein the electrode assembly is formed by a stacking method.

19. The method of manufacturing the secondary battery as claimed in claim 9, wherein the injecting of the electrolyte is performed by an electrolyte injection device while an interior of the electrolyte injection device is in a vacuum state.

20. The method of manufacturing the secondary battery as claimed in claim 9, wherein the case comprises an aluminum laminate film.
